(19) United States
(12) Patent Application Publication
(10) Pub. No.: US 2026/0245986 A1
(43) Pub. Date: Aug. 20, 2026

(54) MONOLITHIC HIGH LOADING ELECTRODES

(71) Applicant: POLYJOULE, INC., Billerica, MA (US)

(72) Inventors: Povtinava Chan, Billerica, MA (US); Olivia Santaus, Billerica, MA (US); Michael Fetcenko, Billerica, MA (US); Mackenzie King, Billerica, MA (US); Eli Paster, Billerica, MA (US)

(21) Appl. No.: 19/164,264

(22) PCT Filed: Mar. 14, 2024
(86) PCT No.: PCT/US2024/019875

§ 371 Date: Sep. 11, 2025

Related U.S. Application Data
(60) Provisional application No. 63/452,030, filed on Mar. 14, 2023.

(51) Int. Cl. H01M 10/42; H01G 11/28; H01G 11/86; H01M 4/04; H01M 4/133; H01M 4/1393; H01M 4/587; H01M 4/62

(52) U.S. Cl. CPC H01M 10/4235; H01G 11/28; H01G 11/86; H01M 4/0435; H01M 4/133; H01M 4/1393; H01M 4/587; H01M 4/624

(57) ABSTRACT

Provided are new electrode constructions that allow for improved energy density and robust structure, optionally without the presence of surface cracks. The electrodes as provided include an electrode active material, the electrode active material optionally comprising carbon at 75 wt % or greater, a current collector optionally incorporated into said electrode active material, and a first fluid permeable sheet layer on or in a first surface of the electrode active material. The presence of the fluid permeable sheet layer as provided herein allows for manufacture of electrodes with high levels of active material without formation of flaws, optionally surface cracking, that interrupt the energy storage or delivery characteristics of the resulting electrode.

### CROSS REFERENCE TO RELATED APPLICATIONS

This application depends from and claims priority to U.S. Provisional Application No. 63/452,030 filed Mar. 14, 2023, the entire contents of which are incorporated herein by reference.

### FIELD

This disclosure related to the field of energy storage. More specifically, this disclosure relates to electrodes and systems that employ those electrodes for electrochemical energy storage and use.

### BACKGROUND

The electrical grid in the US and the world continues to support increasing demand such as from the rise of electrically powered automobiles and mobile devices. Equally important is the need to generate power to support the increase in population and the use of static electronic devices throughout households and businesses such as for computing, refrigeration and manufacture of goods. The increasing load on the electrical grid, therefore, demands generation capabilities that can support continual delivery of reliable energy.

The use of renewable energy sources to power the electrical grid is desired not only due to environmental friendliness, but also for use in remote areas or for in other situations where use of fossil fuels is prohibitive. Unfortunately, the currently most promising renewable energy sources used for power, such as wind or solar, are subject to environmental conditions that are unpredictably variable. The presence of thick cloud cover or still air can reduce the availability of electricity, often at times when such demand is highest. Thus, finding ways to store large amounts of energy is paramount to providing continuous energy delivery to consumers. Storing electrical energy at times when power sources are plentiful and releasing that energy when needed at times when power sources are inadequate creates a system whereby steady energy can be supplied to the consumer.

Supercapacitors are one of the most promising technologies to stabilize delivery of electrical power. Supercapacitors are able to store large amounts of power electrochemically and also deliver that energy quickly and on demand. These attributes allow supercapacitors to perform reliably in a microgrid, as an example, to deliver the needed power to a smaller area when needed or when the general power grid is incapable of satisfying the energy needs due to environmental or other issues. Finding new technologies that can further increase the ability of batteries and supercapacitors to deliver needed energy on demand and store large amounts of that energy when not required are, therefore, greatly needed.

As such, there is a need for improved materials and devices for storage and/or delivery of electrical energy on demand. This disclosure provides new materials with superb energy density thereby enabling improved energy storage and delivery systems such as batteries or supercapacitors. These and other advantages of the disclosure will be apparent from the drawings, discussion, and description that follow.

### SUMMARY

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole.

Provided are electrodes that include: an electrode active material layer including an electrode active material, the electrode active material optionally comprising carbon at 75 wt % or greater; a current collector, said current collector optionally incorporated into said electrode active material; and a first fluid permeable sheet layer, said fluid permeable sheet layer on or in a first surface of said electrode active material. Optionally, the electrode includes less than 1 wt % liquid, and/or optionally wherein said electrode is free of surface cracks. In some aspects, an electrode further comprises a second fluid permeable sheet layer, said second fluid permeable sheet layer on or in a second surface of said electrode active material. Optionally, an electrode optionally has a thickness of about 0.5 mm to about 10 mm, optionally 1 mm to 5 mm, optionally greater than 1 mm, optionally greater than 2 mm. In some aspects, the first and/or second fluid permeable sheet layer has a Gurley air permeability of about 1.0 L/sec/m² or greater, optionally 1250 L/sec/m² or greater, optionally the Gurley air permeability is about 5000 L/sec/m² or greater. Optionally, the fluid permeable sheet layer is non-woven. Optionally, the fluid permeable sheet layer comprises pores with a cross sectional dimension of about 10 m or greater.

An electrode according to any of the above configurations optionally has a Young's modulus of about 1 GPa or less, optionally 0.5 GPa or less, or wherein the electrode has a yield point of equal to or greater than 2% strain, optionally equal to or greater than 3% strain. In some aspects, the electrode active material comprises activated carbon, said activated carbon optionally present at about 50 wt % or greater. Optionally, the electrode active material further comprises a binder, said binder present at about 10 wt % or less. In some aspects, the electrode active material comprises activated carbon, the electrode has a thickness of greater than about 0.5 mm or about 1 mm, and comprises a binder at less than about 10 wt % relative to said electrode active material, and optionally further includes one or more electrically conductive polymers. Optionally, the electrode active material is a solid. Optionally, the electrode has a density of about 2.5 g/cc or less, optionally about 2.0 g/cc or less, optionally about 1.5 g/cc, optionally about 1 g/cc or less, optionally about 0.5 g/cc or less. In some aspects, an electrode further includes one or more rheology modifiers, said rheology modifiers optionally present at 5 wt % or less. In some aspects, the electrode active material comprises a binder, said binder having a glass transition temperature (Tg) of 30 degrees Celsius or lower, optionally −10 degrees Celsius or lower. Optionally, the electrode further includes a conductive agent, optionally comprising carbon, optionally carbon black or graphitic carbon. In some aspects, a current collector is porous. Optionally a current collector comprises a perforated coil structure.

Also provided are processes of forming any of the electrodes as provided herein. A process optionally includes forming a paste comprising the electrode active material; extruding said paste onto either said current collector or said first fluid permeable sheet layer; and calendering said electrode active material to a final thickness of 0.5 mm to 10 mm, optionally 1 mm to 5 mm. The electrode and materials therein optionally further include a second fluid permeable sheet layer, said second fluid permeable sheet layer on or in a second surface of said electrode active material. Optionally, an electrode optionally has a thickness of about 0.5 mm to about 10 mm, optionally 1 mm to 5 mm, optionally greater than 1 mm, optionally greater than 2 mm. In some aspects, the first and/or second fluid permeable sheet layer has a Gurley air permeability of about 1.0 L/sec/m² or greater, optionally 1250 L/sec/m² or greater, optionally the Gurley air permeability is about 5000 L/sec/m² or greater. Optionally, the fluid permeable sheet layer is non-woven. Optionally, the fluid permeable sheet layer comprises pores with a cross sectional dimension of about m or greater.

A process as provided herein optionally forms an electrode according to any of the above configurations optionally having a Young's modulus of about 1 GPa or less, optionally 0.5 GPa or less, or wherein the electrode has a yield point of equal to or greater than 2% strain, optionally equal to or greater than 3% strain. In some aspects, the electrode active material comprises activated carbon, said activated carbon optionally present at about 50 wt % or greater. Optionally, the electrode active material further comprises a binder, said binder present at about 10 wt % or less. In some aspects, the electrode active material comprises activated carbon, the electrode has a thickness of greater than about 0.5 mm or about 1 mm, and comprises a binder at less than about 10 wt % relative to said electrode active material, and optionally further includes one or more electrically conductive polymers. Optionally, the electrode active material is a solid. Optionally, the electrode has a density of about 2.5 g/cc or less, optionally about 2.0 g/cc or less, optionally about 1.5 g/cc, optionally about 1 g/cc or less, optionally about 0.5 g/cc or less. In some aspects, an electrode further includes one or more rheology modifiers, said rheology modifiers optionally present at 5 wt % or less. In some aspects, the electrode active material comprises a binder, said binder having a glass transition temperature (Tg) of 30 degrees Celsius or lower, optionally −10 degrees Celsius or lower. Optionally, the electrode further includes a conductive agent, optionally comprising carbon, optionally carbon black or graphitic carbon. In some aspects, a current collector is porous. Optionally a current collector comprises a perforated coil structure.

### BRIEF DESCRIPTION OF THE DRAWINGS

FIG. 1 illustrates an exemplary process of forming an electrode according to some aspects as provided herein.

FIG. 2 illustrates an alternative exemplary process of forming an electrode according to some aspects as provided herein.

FIG. 3 illustrates an alternative exemplary process of forming an electrode according to some aspects as provided herein.

FIG. 4 illustrates an exemplary process of forming a device incorporating an electrode according to some aspects as provided herein.

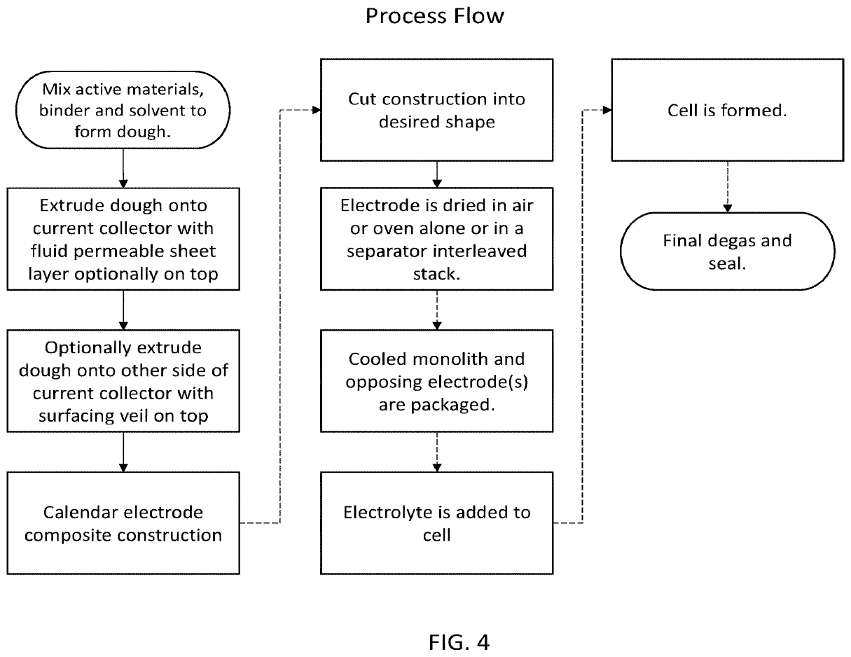

FIG. 5 illustrates illustrative stress/strain curves for an electrode according to some aspects as provided herein.

### DETAILED DESCRIPTION

Provided in this disclosure are new electrodes that may be employed in devices such as batteries, fuel cells, or supercapacitors that dramatically improve energy storage in these systems. Among the issues with electrodes is that the amount of active material incorporated into the electrode is limited by the ability to manufacture the electrodes without introduction of flaws that interrupt the energy storage or delivery characteristics of the resulting electrode. This disclosure provides increased energy storage capability relative to prior materials by creating a structure that incorporates more active material without significant flaws in the structure or performance of the system.

This disclosure provides electrodes that incorporate a fluid permeable sheet layer in or on a surface of the electrode active material. It was found that by incorporating particular fluid permeable sheet layers with the ability to transmit fluid such as water or solvents used in electrode manufacture, on or in the surface of an electrode active material prior to drying, that much thicker electrode active material layers may be used without introduction of cracks or other flaws that traditionally occur when such traditional electrode structures are dried to form the final electrode film. As such, provided herein are electrodes that may be used in batteries, supercapacitors, or other electrical storage devices, that include one or more fluid permeable sheet layers on or in a surface of an active electrode material.

When atomic percentages (at %) are presented and not otherwise defined, the atomic percentages are presented on the basis of the amount of all elements in the described material other than hydrogen and oxygen.

Provided herein are electrodes that include: an electrode active material, a current collector in electrical contact with the electrode active material and a fluid permeable sheet layer on or in a surface of the electrode active material.

The electrodes may be configured such that the fluid permeable sheet layer is spaced apart from the current collector separated therefrom by electrode active material, and optionally on or in a surface that is opposite the current collector that may be exposed to the surrounding environment. A fluid permeable sheet layer optionally does not function as a current collector. Optionally, a fluid permeable sheet layer is made of a material that is considered insulating in the art. The fluid permeable sheet layer may contact the electrode active material on the surface of the electrode active material or may be embedded into the surface of the electrode active material. Optionally, fluid permeable sheet layer is incorporated into the surface of the electrode active material such that some of the surface electrode active material embeds within the fluid permeable sheet. Alternatively, the fluid permeable sheet contacts or is embedded into a surface of the electrode active material and may optionally be bonded chemically, physically, or ionically thereto.

A fluid permeable sheet is optionally embedded into a surface of an electrode active material sheet. Optionally, the fluid permeable sheet is equal to or less than about 40% the thickness of an electrode active material sheet thickness, optionally equal to or less than about 35% the thickness of an electrode active material sheet thickness, optionally equal to or less than about 35% the thickness of an electrode active material sheet thickness, optionally equal to or less than about 25% the thickness of an electrode active material sheet thickness, optionally equal to or less than about 20% the thickness of an electrode active material sheet thickness, optionally equal to or less than about 15% the thickness of an electrode active material sheet thickness, optionally equal to or less than about 10% the thickness of an electrode active material sheet thickness, optionally equal to or less than about 5% the thickness of an electrode active material sheet thickness.

A fluid permeable sheet layer may be permeable to a fluid, or in some instances to particulate solid matter with a particle size sufficiently small to embed within a portion of the fluid permeable sheet layer. A fluid permeable sheet layer may be permeated by gas or liquid solvent materials used in the traditional construction of electrodes. Fluid permeable sheet layer optionally have some level of resistance to permeability by a fluid, optionally as measured by traditional methods of permeability, illustratively Gurley air permeability. As such, a fluid permeable sheet layer may have a pore size or construction that allows transmission of some fluids but not others, or the rate of transmission of one fluid differs relative to a different fluid with different viscosity, elemental or particle size, or other measure.

Optionally, a fluid permeable sheet layer is permeable to water or organic solvents, illustratively, N-methyl-2-pyrrolidone (NMP) or the like. “Permeable” as used herein means that the material or construction of the layer will allow the fluid to pass therethrough, optionally with some level of resistance. In some aspects, a fluid permeable sheet layer will allow water to pass therethrough. In some aspects, a fluid permeable sheet layer will allow organic solvent to pass therethrough. In some aspects, a fluid permeable sheet layer is permeable to solvents used in electrode manufacture as is understood in the art. As such, when a fluid permeable sheet layer is located on or in a surface of an electrode active material prior to drying, the fluid permeable sheet layer will allow the water/solvent present in the active material to pass through the fluid permeable sheet layer thereby allowing drying of the active material to form the final electrode active material layer used in the electrode.

In some aspects, a fluid permeable sheet layer has a permeability that may be measured by the method of Gurley air permeability such as using a Gurley No. 4190 S-P-S Tester. Optionally, the Gurley air permeability of a fluid permeable sheet is 100 L/sec/m² or greater. In some aspects, the Gurley air permeability of a fluid permeable sheet is 5000 L/sec/m² or greater. Optionally, the Gurley air permeability is 1, 10, 50, 100, 200, 300, 400, 500, 600, 700, 800, 900, 1000, 1500, 2000, 2500, 3000, 3500, 4000, 4500, 5000, 5500, 6000, 6500, 7000 L/sec/m² or greater. Optionally, the Gurley air permeability does not exceed 7000 L/sec/m². Optionally, the Gurley air permeability does not exceed 7000 L/sec/m².

A fluid permeable sheet may include a regular or irregular plurality of pores though which fluid may pass. The pores are of a suitable cross-sectional dimension to allow fluid such as water or organic solvent to pass such as when drying an electrode active material. In some aspects, a pore size is 20 micrometers (μm) or greater. In other aspects, a pore size is 20 m to 50 m or any value or range therebetween.

A fluid permeable sheet layer is optionally insulating. An insulating fluid permeable sheet layer optionally has an electrical conductivity of less than or equal to about 1 S/cm, optionally 0.1 S/cm, optionally about 0.01 S/cm, optionally about 0.001 S/cm, optionally about 0.0001 S/cm, optionally about 0.00001 S/cm.

A fluid permeable sheet layer is optionally a woven material or non-woven material, optionally a woven material or non-woven fibrous material. In some aspects, a fluid permeable sheet layer is a non-woven fibrous material that may or may not include bonding, physical or other associations between fibers in the material. A non-woven material is optionally a material that is present in a web of fibers that may optionally be bonded together mechanically, thermally, or electrically. The web of fibers may be laid down by methods known in the art. Illustrative examples of such materials include, but are not limited to a polyester, optionally polyethylene terephthalate (PET), or cellulosic fibers. In some aspects, a fluid permeable sheet layer is a PET non-woven material available from Xamax Industries, Inc. Seymour, CT. In some aspects, a fluid permeable sheet layer is a permeable paper available from Terranova Papers in Barcelona, Spain. In some aspects, the fluid permeable sheet layer is comprised of a non-woven material from Hollingsworth and Vose, Walpole, MA.

An electrode as provided herein includes one or more active materials. An active material is one that is optionally capable of absorbing and desorbing a charged particle such as a positive or negative ion, optionally K, Li, PF6, or BF4. Optionally, an active material is one that associates with at the surface of the material and releases an ion. Illustrative examples of active materials include any material suitable for use in a battery or capacitor electrode. More specifically, active materials include but are not limited to carbons such as graphite, activated carbon, or other carbon materials, transition metal containing oxides or hydroxides, or electrically conductive polymers.

An active material that may be included in an electrode is optionally a hydroxide of Ni alone or in combination with one or more additional metals or other non-metal elements. Optionally, an active material includes Ni and 1, 2, 3, 4, 5, 6, 7, 8, 9, or more additional metals that may include transition metals, post-transition metals or metalloids. Optionally, an active material includes Ni as the sole metal, optionally Ni combined with one or more transition metals, post-transition metals or metalloids. In some aspects, the active material includes one or more of Na or K, or one or more metals selected from the group of Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, a hydride thereof, an oxide thereof, a hydroxide thereof, an oxyhydroxide thereof, or any combination of the foregoing. Optionally, an active material includes one or more of Ni, Co, Mn, Zn, Al, Zr, Mo, Mn, a rare earth, or combinations thereof. In some aspects, an active material includes Ni, Co, Al, or combinations thereof. Ni is optionally present at 10 atomic percent (at %) or greater, optionally 80 atomic percent or greater, optionally 90 at % or greater, optionally 95 at % or greater. Optionally, Ni is the sole metal in the electrochemically active material. Optionally, an active material is Li or a lithium metal material such as lithium titanium oxide. Optionally, an active material includes a metal or other element. It is appreciated that other electrochemically active materials as known in the art may be employed as well.

An active material that may be included herein is optionally any suitable carbon, such as graphite, coke, a hard carbon, or a mesocarbon such as a mesocarbon microbead, for example. Optionally, an active material is a high surface area carbon optionally with a ratio of surface area to mass of 800 m²/g or greater. Optionally, an electrode active material has a desirable porosity to produce the high surface area. Porosity is optionally measured by Hg porosimetry for more macroscopic measurements, or more often nitrogen BET isotherms or ASTM D4607-14 processes, which closely match nitrogen BET methods as is recognized in the art. Optionally, an active material is an activated carbon, microporous carbon, or mesoporous carbon. Some illustrative examples of carbon materials for an active material include activated carbon from coconut shell or other natural source, resin derived carbons, carbon aerogels, carbide-derived carbon, graphene, and single or multi-walled carbon nanotubes. In some aspects, an active material excludes a carbon that is not suitably porous such as graphite or carbon black.

An active material is optionally present in an electrode at 50 wt % or greater. Optionally, an active material is present in an electrode at 50, 60, 70, 80, 85, 90, 91, 92, 93, 94, 95, 69, 97, 98, 99 wt % or greater wherein the weight percent excludes the weight of a current collector or is relative to the total of active material, binder, and any present conductive agent together.

An electrode as provided herein may include an active material intermixed with a binder. The particles (or other aspects of an active material) may be held together by a binder to form a layer in electrical communication with a current collector in the formation of the electrode. The binder may serve to improve the adhesion of the active material and provide desired film characteristics such as but not limited to elasticity, tensile strength or other. A binder is optionally any binder suitable in the art of secondary batteries or supercapacitors, optionally but not limited to polymeric binder materials. In some aspects, a binder has a glass transition temperature (Tg) of 30 degrees Celsius or lower, optionally −10 degrees Celsius or lower. Optionally, a glass transition temperature of a binder is equal to or less than 50, 45, 40, 35, 30, 25, 20, 15, 10, 5, 0, −5, −10, −15, −20, −25, −30, −35, or −40° C.

In some aspects, a binder material is an elastomeric material, optionally being or including styrene-butadiene (SB), styrene-butadiene rubber (SBR), styrene-butadiene-styrene block copolymer (SBS), styrene-isoprene-styrene block copolymer (SIS) and styrene-ethylene-butadiene-styrene block copolymer (SEBS). Illustrative specific examples of a binder include, but are not limited to polytetrafluoroethylene (PTFE), polyvinyl alcohol (PVA), teflonized acetylene black (TAB-2), styrene-butadiene binder materials, or/and carboxymethyl cellulose (CMC).

The weight ratio of active material to binder is optionally from 99:1 to 1:4, optionally 99:1 to 4:1, optionally 98:2 to 85:15. Optionally, the binder is present with the active material at 10 wt % or lower, optionally 9 wt % or lower, optionally 8 wt % or lower, optionally 7 wt % or lower, optionally 6 wt % or lower, optionally 5 wt % or lower, optionally 4 wt % or lower, optionally 3 wt % or lower, optionally 2 wt % or lower, optionally 1 wt % or lower with weight percent relative to total of active material, binder and any present conductive agent.

An electrode (cathode, anode or both) including an active material as provided herein may further include one or more conductive agents intermixed with the active material and/or an electrically conductive polymer. A conductive agent is optionally a conductive carbon. Illustrative examples of a conductive carbon include graphite. Other examples are materials that contain graphitic carbons, such as graphitized cokes or demineralized graphites. Still other examples of possible carbon materials for use as a conductive agent include non-graphitic carbons that may be amorphous, non-crystalline, and disordered, such as petroleum cokes and carbon black. A conductive agent is optionally present in an active material at a weight percent (wt %) of 0.1 wt % to 75 wt %, or any value or range therebetween relative to the total weight of the active material, binder and conductive agent combined. Optionally, the weight percent of the conductive agent is 1 wt % to 60 wt %, or any value or range therebetween. Optionally, the weight percent of the conductive agent is 1 wt % to 15 wt %, or any value or range therebetween. Optionally, the weight percent of the conductive agent is 1 wt % to 10 wt %, or any value or range therebetween.

An electrode as provided herein optionally includes one or more modifiers. A modifier optionally is included to adjust rheology or other physical characteristic of an electrode slurry during manufacture or final electrode physical characteristics. A modifier is optionally present in an electrode at a weight percent (excluding current collector) of about 5% or less, optionally 4% or less, optionally 3% or less, optionally 2% or less. A modifier is optionally present at a weight percent of about 0.01% to about 15%, optionally about 0.01% to about 5%.

A modifier, when present, may include a material suitable for use in a material capable of absorbing and desorbing an ion. Illustrative examples of modifiers include, but are not limited to bentonite, polyvinylpyrrolidone (PVP), lignosulfonate (LS), pectin (P), chopped carbon fiber (CCF), carboxymethyl cellulose (CMC), xanthan gum (Xan), glycerol (G), fumed silica, alkali swellable emulsions (ASE), and any combination thereof. Illustrative examples of PVP include K30 or K90 available from Ashland. Illustrative examples of chopped carbon fiber are as that available from Zoltek Corp. Bridgeton, MO. Illustrative examples of CMC include Texturecel CMC 30K available from DuPont or Walocel CMC 100W available from Dow.

Optionally, combinations of modifiers may be included. Illustrative examples of combinations of modifiers include CCF/K90/Pectin, LS/K90, bentonite/K90, Xan/K30, Xan/K90, Xan/K90/CMC, Xan/G/CMC/K90, Xan/K30/CMC, K90/P, Xan/K30/G/CMC, K30/CMC, K90/K30/CMC, K30/K90/Xan, K30/K90, Xan/G, K30/K90/Xan/G, K90/P, PVP/K90, Xan/LS/K30, LS/K30, Bentonite/K90, or any combination thereof. Optionally, all modifiers other than glycerol are present at less than about 3 wt %, optionally less than about 2 wt %.

In some aspects, a first electrode, a second electrode or both, includes or is one or more electrically conductive polymers. Such electrodes may be as described in International patent application publication number WO 2020/092213. Alternatively, such first or second electrodes may be as described in U.S. Patent Application No. 63/342,243. Accordingly, an electrode may include a film of electrically conductive polymer that is optionally continuous or discontinuous.

The electrode may include one or more electrically conductive polymers as an active or contributing component of an electrode such as is suitable for use in a battery or supercapacitor. The electrically conductive polymers alone or in combination with other electrode materials provide excellent energy density and capability to rapidly deliver electrical power on demand. In some aspects, an electrically conductive polymer may include a plurality of monomers, wherein the plurality of monomers are conjugated in a polymeric linkage optionally with a kinking factor of 0.25 or less. Kinking within a conjugated polymer may arise due to one or more intervening structures or orientations of monomers that reduce or eliminate the ability to transport an electron through the polymer. Such kinking may occur due to the presence of an introduced 2,4 diyl, the rotation of a bond between monomers that interrupts electron transport, or by the presence of an impurity whereby an impurity is a chemical structure that alters or eliminates electron transport though the chain (e.g. intermediate non-conjugated monomer, metal or halogen). As used herein, a “kinking factor” is a measure of a structural characteristic of the polymer that leads to an observed kink within a polymer. Specifically, a kinking factor as provided herein is the peak intensity ratio of 682 cm⁻¹/700 cm⁻¹ measured by Raman spectroscopy. It was found that polymers with a kinking factor of 0.25 or lower are particularly well suited for use in electrodes such as those that may be employed in energy storage devices. As such, an electrically conductive polymer optionally has a kinking factor of 0.25 or less. Optionally, a kinking factor is 0.20 or lower. Optionally, a kinking factor is equal to or lower than 0.25, 0.24, 0.23, 0.22, 0.21, 0.2, 0.19, 0.18, 0.17, 0.16, 0.15, 0.14, 0.13, 0.12, 0.11, 0.1, 0.09, 0.08, 0.07, 0.06, 0.05, 0.04, 0.03, 0.02, or 0.01. Optionally, a kinking factor is at or between 0.25 and 0.01, optionally at or between 0.02 and 0.01, optionally at or between 0.15 and 0.01.

An electrically conductive polymer used in an electrode optionally includes a plurality of chain monomers. In some aspects, the plurality of chain monomers is homomeric meaning that, other than the presence of a cap or other intervening structure, the conjugated sections of the polymer contain predominantly the same type of chain monomer. Alternatively, the plurality of chain monomers is heteromeric meaning that the conjugated chain monomer system includes chain monomers of differing structure, wherein the differing structure excludes the structure of a cap when present.

A monomer (e.g. chain or cap) optionally is or includes a cyclic structure, optionally a ring structure. A ring structure may include 3, 4, 5, 6, or members within the ring. Optionally, a monomer is or includes a five membered ring structure. Optionally, a monomer is or includes a six membered ring structure. The monomers, optionally chain monomers, however, include a conjugation within the monomer structure, and/or with one or more adjacent monomers so as to form a conjugated polymer structure. As such, a monomer optionally is or includes an aromatic structure to form an aromatic monomer.

In some aspects, the chain monomers may be or include a heterocyclic structure wherein one or more heteroatoms are present within the monomer. A heteroatom is optionally N, O, S, P, or any combination thereof within the ring structure. In some aspects, a heteroatom is S. in some aspects, a heteroatom is O. Optionally, a heteroatom is N. Optionally, a polymer excludes a heterocyclic ring structure with a heteroatom of O, N or P.

As such, a chain monomer as used in a polymer as provided herein is optionally a substituted or unsubstituted thiophene, benzothiophene, thianthrene, furan, tetrahydrofuran, pyran, isobenzofuran, chromene, xanthene, phenoxathiin, pyrrole, dihydropyrrole, pyrrolidine, imidazole, pyrazole, pyrazine, isothiazole, isoxazole, pyridine, pyrazine, pyrimidine, pyridazine, indolizine, isoindole, indole, indazole, purine, quinolizine, isoquinoline, quinoline, phthalazine, naphthyridine, quinoxaline, quinazoline, cinnoline, pteridine, carbazole, carboline, triazole, tetrazole, oxazole, isoxazole, thiazole, isothiazole, phenanthridine, acridine, pyrimidine, phenanthroline, phenazine, phenarsazine, phenothiazine, furazan, phenoxazine, pyrrolidine, oxolane, thiolane, oxazole, oxazine, piperidine, homopiperidine (hexamethyleneimine), piperazine (e.g., N-methyl piperazine), morpholine, triazines, benzoquinones, anthraquinones, dianhydrides, lactones, lactams such as azetidinones and pyrrolidinones, sultams, sultones, other saturated and/or unsaturated derivatives thereof. Optionally, a chain monomer includes or is a pyrrole, thiophene, aniline, phenyl, benzene, mixtures thereof, and/or derivatives thereof. Optionally, a plurality of chain monomers includes a thiophene, a phenol, benzene, or combinations thereof. Optionally, a plurality of chain monomers includes a thiophene, a phenol, or combinations thereof. Optionally, a polymer includes a plurality of any of the foregoing that may include a cap that includes one or more cap monomers of phenol, optionally a polythiophene with a cap that that includes one or more cap monomers of phenol.

An electrically conductive polymer may include one or more hydrogen-bondable moieties such as described in WO 2020/092213. Illustratively, the presence of a hydrogen-bondable moiety may create a polymer with similar electrochemical properties as compared to their non-hydroxylated derivatives, but form stronger and more flexible polymer films. Optionally, at least a small molar percentage of hydrogen-bondable moieties may improve electrochemical properties as compared to derivatives without the hydrogen-bondable moieties.

With respect to a hydrogen-bonding moiety, “hydrogen-bond”, as used herein, is given its ordinary meaning in the art and generally refers to a partially electrostatic attraction between a hydrogen (H) atom and a more electronegative atom (e.g., such as nitrogen (N), oxygen (O), fluorine (F), and/or another atom adjacent that H atom that bears a lone pair of electrons). The term “hydrogen-bondable”, as used herein, is given its ordinary meaning in the art and generally refers to a moiety (e.g., a functional group, a portion of a molecule) which comprises a group capable of forming a hydrogen-bond with another atom.

The hydrogen-bondable moiety may optionally be present at 25 mol % or less relative to a chain monomer as described herein. Optionally, a hydrogen bondame moiety is present at or less than 20 mol %, optionally 15 mol %, optionally 10 mol %, optionally 5 mol %, optionally 3 mol %, optionally 2 mol %, optionally 1 mol %.

Illustrative examples of a hydrogen-bondable moiety include but are not limited to hydrogen-bondable aromatic additives. Such hydrogen bondable aromatic additives optionally include phenol, thiophenol, catechol, o-cresol, m-cresol, p-cresol, 2,4-di-tert-butylphenol, bisphenol A, 2,2′-biphenol, 4-pentadecyl phenol, 2-ethoxyphenol, 2-acetamidophenol, 4 hydroxydiphenylamine, 4-phenyl phenol, gallic acid, tannic acid, 1-napthol, 2-napthol, poly(4-vinylphenol), and/or mixtures thereof.

An electrically conductive polymer may include one or more chain monomers with a non-hydrogen substituent. A non-hydrogen substituent is a substituent that includes at least one atom that is not a hydrogen or excludes a hydrogen within the substituent. Illustrative examples of substituents as provided herein include but are not limited to substituents include, but are not limited to a halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF3, —CN, aryl, aryloxy, perhaloalkoxy, aralkoxy, heteroaryl, heteroaryloxy, heteroarylalkyl, heteroaralkoxy, azido, amino, halide, alkylthio, oxo, acylalkyl, carboxy esters, carboxamido, acyloxy, disulfide, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, cyano, alkoxyalkyl, perhaloalkyl, or arylalkyloxyalkyl. Optionally, a substituent is or includes a halogen atom, and/or a linear or branched alkyl, alkoxy, or alkyl ester group having from 1 to 20 carbon atoms, optionally 1-5 carbon atoms, optionally 1-2 carbon atoms. In some aspects, a substituent includes C1-C5 alkyl ester, optionally a C1 alkyl ester, optionally a C2 alkyl ester, optionally a C3 alkyl ester, optionally a C4 alkyl ester. In other aspects, a non-hydrogen substituent is or includes a halogen. A halogen is optionally F, Cl, Br, or I. A chain monomer optionally includes one or more substituents, optionally 1, 2, 3, or more. Optionally, a chain monomer includes one substituent, optionally a halogen or a linear or branched alkyl, alkoxy, or alkyl ester group having from 1 to 20 carbon atoms. It was found that aperiodic inclusion of one or more substituents within the electrically conductive polymer at one or more chain monomers or other location creates a system with consistently better electrochemical activity of the polymer when incorporated into an electrode. The one or more substituents is optionally present within the polymer chain at 0.01 mol % relative to the chain monomer total moles to 10 mole % or greater. Optionally, the one or more substituents is present within the polymer at 0.02 mol %, optionally 0.05 mole %, optionally 0.08 mol %, optionally 0.1 mole %, optionally 0.2 mol %, optionally 0.3 mol %, optionally 0.4 mol %, optionally 0.5 mol %, optionally 0.6 mol %, optionally 0.7 mol %, optionally 0.8 mol %, optionally 0.9 mol %, optionally 1 mole %, optionally 2 mol %, optionally 3 mol %, optionally 4 mol %, optionally 5 mol %, optionally 6 mol %, optionally 7 mol %, optionally 8 mol %, optionally 9 mol %, optionally 10 mol %, or greater.

In some aspects, a substituent is an alkyl ester, optionally a C1-C5 alkyl ester, optionally a C1 alkyl ester, optionally a C2 alkyl ester, optionally a C3 alkyl ester, optionally a C4 alkyl ester. An alkyl ester is optionally present on a chain monomer, a cap monomer, or both. Optionally, an alkyl ester is present on a chain monomer. Optionally, an alkyl ester is present relative to chain monomer at 0.01 mol % relative to the chain monomer total moles to 10 mole % or greater. Optionally, the alkyl ester is present within the polymer at 0.02 mol %, optionally 0.05 mole %, optionally 0.08 mol %, optionally 0.1 mole %, optionally 0.2 mol %, optionally 0.3 mol %, optionally 0.4 mol %, optionally 0.5 mol %, optionally 0.6 mol %, optionally 0.7 mol %, optionally 0.8 mol %, optionally 0.9 mol %, optionally 1 mole %, optionally 2 mol %, optionally 3 mol %, optionally 4 mol %, optionally 5 mol %, optionally 6 mol %, optionally 7 mol %, optionally 8 mol %, optionally 9 mol %, optionally 10 mol %, or greater.

As used herein, the term “alkyl” refers to the radical of saturated aliphatic groups, including straight-chain alkyl groups, branched-chain alkyl groups, cycloalkyl (alicyclic) groups, alkyl substituted cycloalkyl groups, and cycloalkyl substituted alkyl groups. In some embodiments, a straight chain or branched chain alkyl may have 30 or fewer carbon atoms in its backbone, and, in some cases, 20 or fewer. In some embodiments, a straight chain or branched chain alkyl has 12 or fewer carbon atoms in its backbone (e.g., C1-C12 for straight chain, C3-C12 for branched chain), or, in some cases, 6 or fewer, or 4 or fewer. Likewise, some cycloalkyls have from 3-10 carbon atoms in their ring structure, or have 5, 6 or 7 carbons in the ring structure. Examples of alkyl groups include, but are not limited to, methyl, ethyl, propyl, isopropyl, cyclopropyl, butyl, isobutyl, tert-butyl, cyclobutyl, hexyl, cyclohexyl, and the like.

The term “heteroalkyl” refers to an alkyl group as described herein in which one or more carbon atoms is replaced by a heteroatom. Suitable heteroatoms include oxygen, sulfur, nitrogen, phosphorus, and the like. Examples of heteroalkyl groups include, but are not limited to, alkoxy, amino, thioester, and the like.

The term “aryl” refers to aromatic carbocyclic groups, optionally substituted, having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl). That is, at least one ring may have a conjugated pi electron system, while other, adjoining rings can be cycloalkyls, cycloalkenyls, cycloalkynyls, aryls and/or heterocyclyls. The aryl group may be optionally substituted, as described herein. “Carbocyclic aryl groups” refer to aryl groups wherein the ring atoms on the aromatic ring are carbon atoms. Carbocyclic aryl groups include monocyclic carbocyclic aryl groups and polycyclic or fused compounds (e.g., two or more adjacent ring atoms are common to two adjoining rings) such as naphthyl groups.

The term “heteroaryl” refers to aryl groups comprising at least one heteroatom as a ring atom.

The term “heterocyclyl” refers to refer to cyclic groups containing at least one heteroatom as a ring atom, in some cases, 1 to 3 heteroatoms as ring atoms, with the remainder of the ring atoms being carbon atoms. Suitable heteroatoms include oxygen, sulfur, nitrogen, phosphorus, and the like. In some cases, the heterocycle may be 3- to 10-membered ring structures, or in some cases 3- to 7-membered rings, whose ring structures include one to four heteroatoms. The term “heterocycle” may include heteroaryl groups (e.g., aromatic heterocycles), saturated heterocycles (e.g., cycloheteroalkyl) groups, or combinations thereof. The heterocycle may be a saturated molecule, or may comprise one or more double bonds. In some case, the heterocycle is an aromatic heterocycle, such as pyrrole, pyridine, and the like. In some cases, the heterocycle may be attached to, or fused to, additional rings to form a polycyclic group. In some cases, the heterocycle may be part of a macrocycle. The heterocycle may also be fused to a spirocyclic group. In some cases, the heterocycle may be attached to a compound via a nitrogen or a carbon atom in the ring.

An electrode as provided herein optionally includes a current collector in electrical contact with an active material. It may be appreciated, however, that some aspects exclude a current collector in an electrode. When present, a current collector may be in the form of a mesh, foil, or other suitable form. A current collector is optionally in the form of a sheet, and may be in the form of a foil, solid substrate, porous substrate, grid, foam or foam coated with one or more metals, perforated structure, perforated coil structure, or other form known in the art. In some aspects a current collector is in the form of a foil. Optionally, a grid may include expanded metal grids and perforated foil grids.

A current collector may be formed of any material that is suitably conductive of electrons to be used in an electrode. A current collector is optionally formed of any suitable electrically conductive and optionally impermeable or substantially impermeable material, including, but not limited to stainless steel, titanium, copper, or carbon papers/films, a non-perforated metal foil, aluminum foil, cladding material including nickel and aluminum, cladding material including copper and aluminum, nickel plated steel, nickel plated copper, nickel plated aluminum, gold, silver, any other suitable electronically conductive material or any suitable combination thereof. Optionally, a current collector may be formed of one or more suitable metals or combination of metals (e.g., alloys, solid solutions, plated metals). Optionally, a current collector may be formed of aluminum, such as an aluminum alloy, nickel or nickel alloy, steel such as stainless steel, copper or copper alloys, or other such material. In some aspects, a current collector includes one or more metals in any suitable configuration and coated in part or in total with carbon wherein a carbon coating is a material layer distinguishable from any carbon used as an electrochemically active material. A carbon coating on a metallic current collector optionally includes carbon coating up to a thickness of 40 microns or less, optionally 20 microns or less, optionally 10 microns or less. In some aspects, a current collector includes aluminum coated in part or in total with carbon.

The current collector may include or be in electrical communication with one or more tabs to allow the transfer of electrons from the current collector to a region exterior of the electrode and to connect the current collector(s) to a circuit so that the electrons produced during discharge of any cell or device employing the electrode may be used to power one or more devices or otherwise deliver electrical energy to any system (e.g. power grid). A tab may be formed of any suitable conductive material (e.g. Ni, Al, or other metal) and may be welded onto the current collector. Optionally, each electrode has a single tab.

A current collector is in electrical contact with an active material, optionally in direct contact with an active material. An active material may be coated onto a current collector, or a current collector may be embedded within an active material. Optionally, a current collector is embedded within an active material such that active material extends from and is present on both sides of the current collector.

Among the innovative features of the electrodes as provided herein is the ability to include high loadings such as by providing greater thicknesses of active material and optionally at lower binder percentages than was previously achievable in the absence of surface cracking or other defects occurring in the material due to drying of the slurry in electrode formation. When electrodes are formed from slurry casting or extrusion, the water or organic solvent used to make the slurry and achieve the necessary uniformity of active material and binder needs to be removed. Solvent removal is traditionally achieved by drying the electrode films at elevated temperatures or other method. When electrode films have a thickness of 0.5 mm or greater for some materials but more so greater than 1 mm, this drying process results in non-uniform evaporation throughout the thickness of the material resulting in surface cracks such as cracks from the surface penetrating through all or a portion of the thickness of the material and often all the way to the current collector or producing otherwise brittle films. The combination of the fluid permeable layer as provided in the electrodes herein prevents this introduction of cracking or defects and provides a much more robust and thicker electrode material than was previously achievable.

As such, an electrode as provided herein has a thickness. A thickness is optionally the distance perpendicular to the plane of a current collector to an opposing surface of the electrode. A thickness is optionally greater than 0.5 millimeters (mm). Optionally, a thickness is 0.5 mm to 10 mm or any value or range therebetween, optionally 1 mm to 5 mm. Optionally, a thickness is greater than 1 mm, optionally greater than 1.2 mm, optionally greater than 1.4 mm, optionally greater than 1.5 mm, optionally greater than 1.75 mm, optionally greater than 2 mm.

The drying process seeks to remove the solvent. The residual solvent (e.g. water or organic solvent) in the active material is optionally 1 wt % or less. In some aspects, the electrode has a thickness of 0.5 mm to 10 mm, optionally 1 mm to 5 mm, optionally greater than 1 mm, optionally greater than 2 mm, along with less than 1 wt % solvent, and a binder at 10 wt % or less, optionally 5 wt % or less, optionally, 3 wt % or less.

The resulting electrode materials are uniquely robust in being both of increased thickness and substantially free of surface cracking or the like defects, but also with a flexibility and other physical characteristics to be resilient to abuse and employed in more fields and shapes that was previously achievable. As such, an electrode optionally has a Young's modulus of less than or equal to 1 GPa, optionally less than or equal to 500 MPa, optionally equal to or less than 400 MPa. In some aspects, an electrode is sufficiently robust that a yield point (point in the stress-strain curve at which the curve levels off and plastic deformation begins to occur) is equal to or greater than 2% strain, and more often at or in excess of 3% strain, 4% strain, and often equal to or greater than 5% strain.

An electrode may be formed by any method known in the art such as by slurry formation and coating or dry coating processes. For example, an active material alone or with another material may be combined with a binder, and optionally conductive material, in an appropriate solvent to form a slurry. In some aspects, the slurry is thin such as in the presence of relatively greater amount of solvent, or the slurry is more in the context of a paste such as when relatively less solvent is used. In some aspects, a slurry includes 40% by weight solids or less. Optionally, a solvent in a slurry or paste is present at a weight percent of about 57% to about 61%, optionally about 58% to about 61%, optionally about 60%. The slurry or paste may be coated onto a current collector, combined with a fluid permeable sheet layer, and dried to evaporate some or all of the solvent to thereby form a film layer in contact with the current collector and the fluid permeable film layer. Any suitable solvent may be used. Optionally, a solvent is an aqueous solvent, optionally water or predominantly water. In some aspects, following coating, a fluid permeable film layer is removed in part or in whole.

The slurry may be cast or extruded onto a surface such as a surface of a current collector and/or a fluid permeable sheet material. Simultaneous with or following contacting the surface, the active material may also contact a second surface such as a second current collector or a second fluid permeable sheet material. The resulting layered structure may then be calendered or otherwise compressed into the desired final thickness as described herein.

The electrodes may have density of the active material of about 2.5 grams of active material per cubic centimeter (g/cc) or less, optionally about 2.0 g/cc or less, optionally, optionally about 1.5 g/cc, optionally about 1.2 g/cc or less, optionally about 1 g/cc or less, optionally about 0.75 g/cc or less, optionally about 0.5 g/cc or less, optionally, optionally about 0.4 g/cc or less.

As such, a multilayered electrode structure may be formed. The multilayered structure may include an active material layer, a first fluid permeable film layer optionally on or in an active material layer, and a current collector layer where the current collector is optionally in contact with, optionally integrated into the active material layer. The current collector and/or the first fluid permeable film layer may be embedded in the active material layer. Optionally, a current collector is present within an active material layer, optionally by forming an active material layer on both sides of a current collector, optionally such that the current collector is fully embedded within active material, and a first fluid permeable film layer may be formed on or in a first surface of the active material layer, and a second fluid permeable film layer may be formed on or in a second surface of the active material layer. In such a way, an electrode with two environmentally exposed surface layers is achieved.

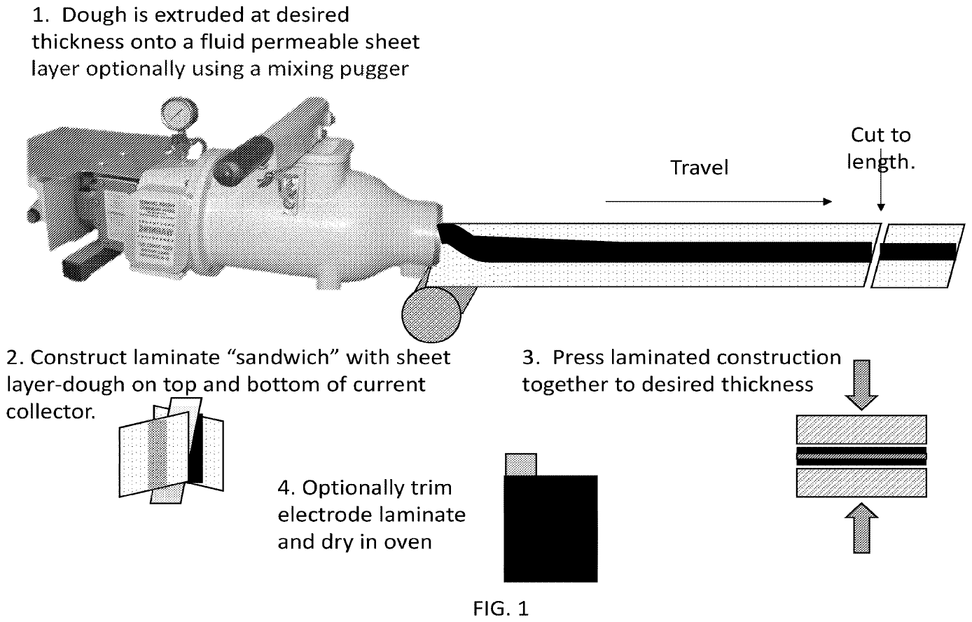

As an example of the formation of some aspects of an electrode as provided herein, FIG. 1 illustrates extrusion of a paste including an active material (alone or in combination with a binder, optionally a conductive agent, and a solvent) onto the surface of a permeable current collector. This may then be optionally cut to a desired length and width dimension and contacted with a first fluid permeable sheet layer on a first surface of an active material and a second fluid permeable sheet layer may be contacted on the opposing surface of the current collector. The resulting layers may then be pressed such as by calendering or other method to impregnate the active material into the current collector and placing active material in contact with both fluid permeable sheets to form a layered structure. This may be then dried and optionally welded to a tab to form the final electrode.

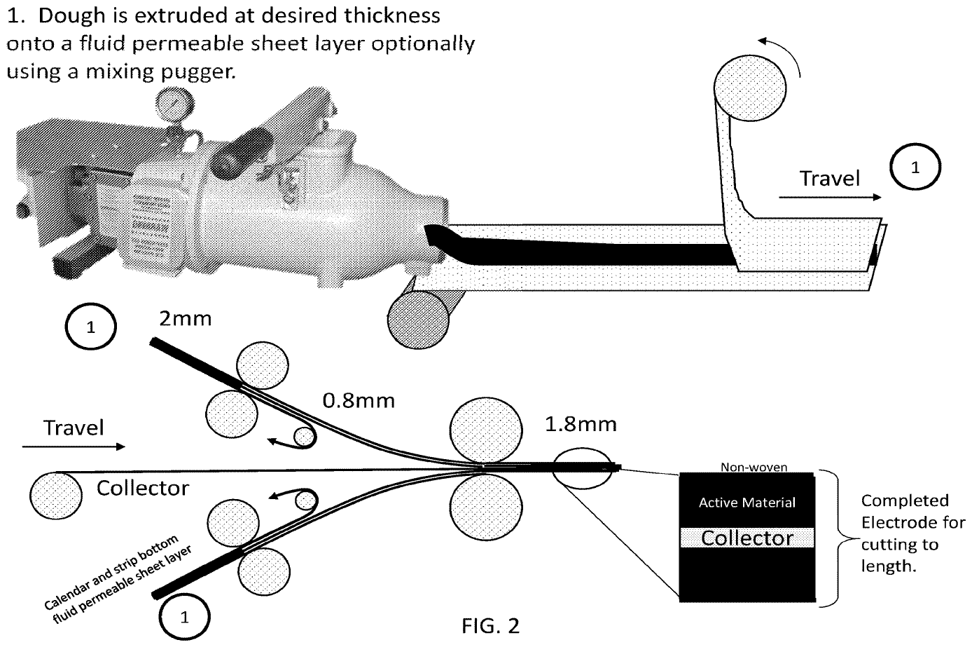

An alternative process of forming an electrode is illustrated in FIG. 2. In this example, a sequential calendering system is used. An active material may be cast or extruded onto the surface of a first fluid permeable sheet layer that is simultaneous with or after contacted on the opposing side of the active material with a second fluid permeable sheet. Two such layered structures may be calendered after which a second fluid permeable sheet layer is removed from one side and that side place in contact with a current collector. Similarly, a second layered structure has a second fluid permeable sheet layer removed and the active material contacted with the second side of the current collector. The resulting layered structure with two fluid permeable membranes on opposing sides of the electrode and the current collector in between two layers of active material may be calendered to a desired thickness, dried, and cut to desired size. The final electrode may be welded to a tab.

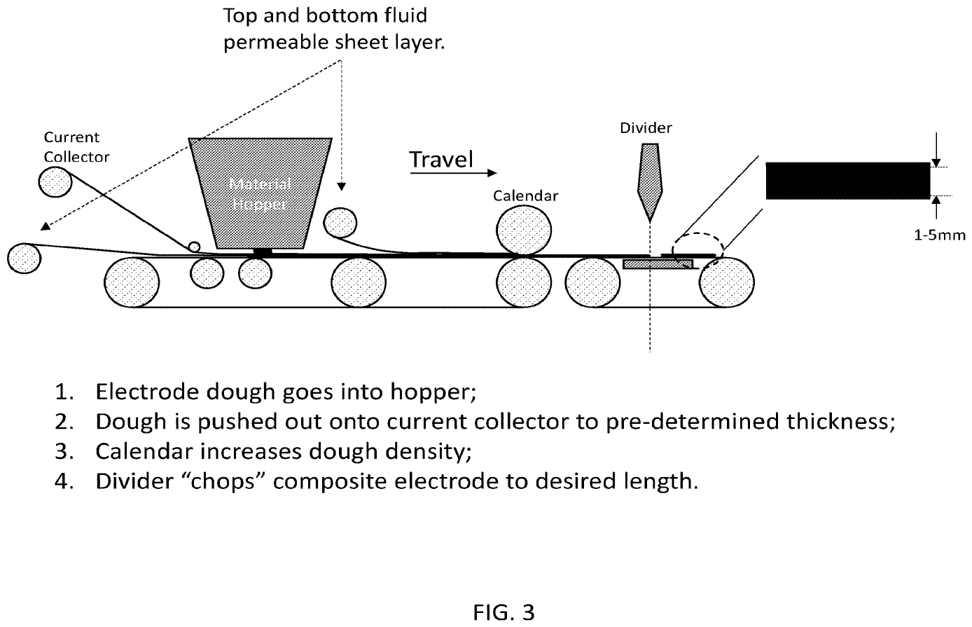

In further aspects, FIG. 3 illustrates a manufacturing process whereby a first fluid permeable sheet material is layered onto one surface of a current collector. An active material may be delivered by an extruder, hopper, or other to the opposite side of the current collector and a second fluid permeable sheet layer is contacted to the opposing surface of the active material. The resulting layered structure is calendered to a desired thickness and density and then the material is cut to desired dimensions and dried. The electrode may be welded to a tab for inclusion in a battery or supercapacitor.

The electrodes as provided herein may be employed in one or more energy storage devices. An energy storage device is optionally a supercapacitor or a battery. Supercapacitors function by separating ions from an electrolyte in the presence of a voltage applied to two electrodes. Positive charged ions are contacted to the surface of a first electrode and negative ions are contacted to the opposing electrode. The static binding of these respective ions provides the desired capacity for use during discharge of the supercapacitor to provide relatively high current and long cycle life. The increased surface area provided by active materials such as activated carbon and others as provided herein and known in the art allows for much greater binding of ions driven by porosity and surface area of each electrode.

As such, a supercapacitor may be either symmetric or asymmetric. Symmetric supercapacitors include the same or similar electrode materials for both the cathode and the anode. In some instances, electrodes as provided herein may be used for both a cathode and an anode. Alternatively, an electrode as provided herein is used in an asymmetric supercapacitor whereby an opposing electrode is of a differing material or structure, optionally similar material but of differing pore size to accommodate different ion dimensions.

An electrode as provided herein may be employed in a device, optionally a battery or supercapacitor, as a portion of a cathode or anode. Optionally, an electrode is employed in a device as an anode. Optionally, an electrode is employed in a device as a cathode. Optionally, an electrode as provided herein is employed as both a cathode and an anode. A device may include a housing that further includes a separator, and electrolyte, or both. A separator may be placed adjacent (e.g., directly adjacent) to the electrode and a second or opposing electrode, but is not imbedded in or otherwise present within or within a surface of an electrode. An electrolyte may be arranged between first electrode and second electrode (e.g., via the separator material), such that the electrolyte is in contact with both first electrode and second electrode. A separator may be a microporous membrane, and may include a porous film including polypropylene, polyethylene, or a combination thereof, or may be a woven or non-woven insulating material such a glass-fiber mat or non-woven cellulose.

In some aspects, a cell includes a first electrode is formed from a current collector composed of an about 0.1 mm thick aluminum foil, with the foil containing about 6.35 mm holes perforated throughout the collector in a grid pattern, such that approximately 22% of the foil is open area. The current collector is embedded in a first electrode active film is formed of about 75% polythiophene, 20% conductive agent, 5% binder and rheology modifiers, in which one or two fluid permeable sheets are used with the one or two fluid permeable sheets having a Gurley number of about 1750 L/sec/m² and optionally located on or within about 25% of the thickness of both the top and bottom surfaces of the first electrode. A second electrode is includes a second electrode active material film composed of about 89% activated carbon, about 5% conductive agent, and about 6% binder and rheology modifiers, containing two fluid permeable sheets, with a Gurley number of about 1750 L/sec/m², and optionally located within 25% of, optionally on, the top and bottom surfaces of the second electrode. A 0.040 mm thick, separator formed at least in part of cellulose is located between the first and the second electrodes. The cell further may include any of the following electrolytes.

A device may further include an electrolyte. Any suitable electrolyte may be used. The electrolyte may be arranged to be in electrochemical communication with the first and second electrodes (e.g., the first electrode and second electrode are in contact with a common electrolyte). The electrolyte can be any of a variety of materials capable of transporting and optionally providing either positively or negatively charged ions, or a proton between two electrodes and should be chemically compatible with the electrodes. In some cases, the electrolyte is selected to be capable of supporting high charge stabilization.

Optionally, the electrolyte is a liquid electrolyte. As a non-limiting example, the electrolyte may be an ionic liquid. For example, the electrolyte may be 1-ethyl-3-methylimidazolium tetrafluoroborate. Other examples of electrolytes include ethylene carbonate solutions, dimethyl carbonate solutions, dimethyl carbonate, ethyl methyl carbonate, diethyl carbonate, ethylene carbonate, propylene carbonate, acetonitrile, lithium salt containing electrolytes, and/or propylene carbonate solutions, which include at least one salt having the formula, [(R)₄N⁺][X⁻], wherein X is (PF₆)⁻, (BF₄)⁻, (SO₃R^{a})⁻, (R^{a}SO₂—N—SO₂R^{a})—, or (CF₃)₂CHO)—, wherein R is alkyl and R^{a} is alkyl, aryl, fluorinated alkyl, or fluorinated aryl. Optionally, the liquid electrolyte may include N-ethyl-N-(2-methoxyethyl)-N,N-dimethylammonium tetrafluoroborate. Optionally, the electrolyte may be a solid ceramic electrolyte. Optionally, and electrolyte includes a lithium salt, optionally LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiCl, LiI, or LiB(C₂O₄)₂ (lithium bis(oxalato) borate; LiBOB). Optionally, the electrolyte includes a potassium salt, optionally KPF₆, KBF₄, KFSI, or KTFSI.

The anode, cathode, separator, and electrolyte may be housed in a cell case (e.g. housing). The housing may be in the form of a metal or polymeric can, or can be a laminate film, such as a heat-sealable foil, optionally aluminum foil, or an aluminum coated polypropylene film. The device may have any suitable configuration or shape, and may be cylindrical or prismatic.

A device may be charged and/or discharged during normal operation. According to certain embodiments, the energy storage device may have to be charged and/or discharged in order to store energy (e.g., as energy density of the device). Therefore, in certain embodiments, the device can be charged and/or discharged at a potential window between 0 V and 6.5 V. According to some embodiments, the potential window may change depending on the composition of components in the energy storage device.

Various aspects of the present disclosure are illustrated by the following non-limiting examples. The examples are for illustrative purposes and are not a limitation on any practice of the present invention. It will be understood that variations and modifications can be made without departing from the spirit and scope of the invention.

### EXPERIMENTAL

### Example 1

An electrode employing a thick activated carbon material and a fluid permeable layer is formed by combining activated carbon (Kuraray, Tokyo Japan) with a conductive agent (Imerys, Paris, France) and CMC binder in water. The formulation is as presented in Table 1.

TABLE 1
exemplary active material layer composition during formation.

| | | | w/w % with |
|---|---|---|---|
| Ingredient | Function | w/w % Dry | water |
| Activated Carbon | active material | 89 | 35 |
| Carbon black | conductive agent | 4 | 1.6 |
| Graphitic carbon | conductive agent | 4 | 1.6 |
| Carboxymethyl cellulose | binder | 3 | 1.2 |
| Water | solvent | N/A | 60.6 |

In forming the active material, the dry materials of the activated carbon, the carbon black and the graphitic carbon are intermixed with the CMC binder. The water is then added to the dry powder mixture and intermixed for about 10 minutes. Near the end of the 10 minute mixing time the granulated powder turns into a thicker material after which the material is intermixed at increased power for an additional 5 minutes until a paste is formed. The paste may then be coated onto a current collector and/or a fluid permeable membrane and calendered to form an electrode. The resulting electrode has a final density of 0.45 g/cc and a thickness of 1-5 mm.

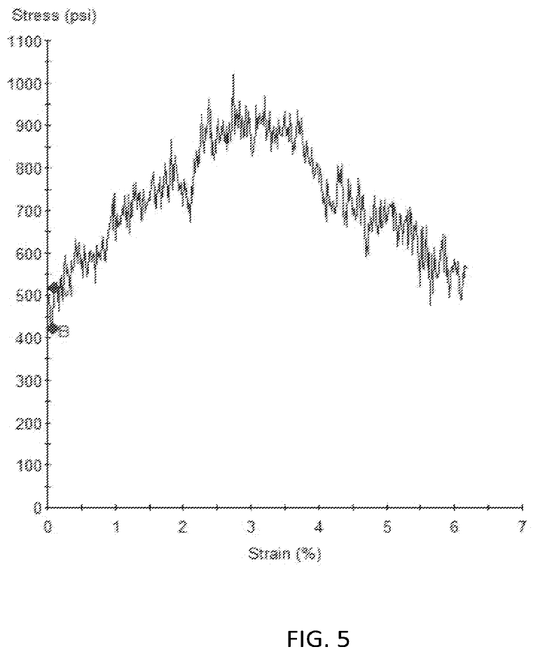

The resulting materials are tested for determination of physical parameters by three-point bend testing according to ASTM D790 using an Instron 1125 universal mechanical tester with an Instru-Met Corporation digital interface controlled by MTS TestWorks data collection software suite. Testing was conducted with a crosshead compression speed of 7.38 mm/min (calculated using guidance from ASTM D790). This test was set to terminate at a strain endpoint of 8%, to clearly include all data up to 5% strain as required by ASTM D790 (assuming no failure prior to 5% strain). The support span of the 3-point bend jig was 28.94 mm. The support and load cylinders had radii of 6.33 mm. A plot of stress (psi)/% strain of an exemplary material is illustrated in FIG. 5. A calculated Young's modulus for all samples was less than 1 GPa and most all less than 0.4 GPa.

### ADDITIONAL ASPECTS

Aspect 1. An electrode comprising: an electrode active material, the electrode active material optionally comprising carbon at 75 wt % or greater; a current collector, said current collector optionally incorporated into said electrode active material; and a first fluid permeable sheet layer, said fluid permeable sheet layer on or in a first surface of said electrode active material, optionally wherein said electrode comprises less than 1 wt % liquid, and optionally wherein said electrode is free of surface cracks.
Aspect 2. The electrode of aspect 1 further comprising a second fluid permeable sheet layer, said second fluid permeable sheet layer on or in a second surface of said electrode active material.
Aspect 3. The electrode of aspects 1 or 2, wherein said electrode active material has a thickness of about 0.5 mm to about 10 mm, optionally 1 mm to 5 mm, optionally greater than 1 mm, optionally greater than 2 mm.
Aspect 4. The electrode of aspects 1-3, wherein said first fluid permeable sheet layer has a Gurley air permeability of about 1.0 L/sec/m² or greater, optionally 1250 L/sec/m² or greater.
Aspect 5. The electrode of aspect 4, wherein said air permeability is about 5000 L/sec/m² or greater.
Aspect 6. The electrode of aspects 1-5, wherein said fluid permeable sheet layer is non-woven.
Aspect 7. The electrode of aspects 1-6, wherein said fluid permeable sheet layer comprises pores with a cross sectional dimension of about 10 m or greater.
Aspect 8. The electrode of any one of aspects 1-7, wherein said electrode has a Young's modulus of about 1 GPa or less, optionally 0.5 GPa or less, or wherein the electrode has a yield point of equal to or greater than 2% strain, optionally equal to or greater than 3% strain.
Aspect 9. The electrode of any one of aspects 1-8, wherein said electrode active material comprises activated carbon, said activated carbon optionally present at about 50 wt % or greater.
Aspect 10. The electrode of any one of aspects 1-9, wherein said electrode active material further comprises a binder, said binder present at about 10 wt % or less.
Aspect 11. The electrode of any one of aspects 1-10, wherein said electrode active material comprises activated carbon, the electrode has a thickness of greater than about 0.5 mm, and comprises a binder at less than about 10 wt % relative to said electrode active material, and optionally further includes one or more conductive polymers.
Aspect 12. The electrode of any one of aspects 1-11, wherein said electrode active material is a solid.
Aspect 13. The electrode of any one of aspects 1-12, wherein said electrode has a density of about 2.5 g/cc or less, optionally about 2.0 g/cc or less, optionally about 1.5 g/cc, optionally about 1 g/cc or less, optionally about 0.5 g/cc or less.
Aspect 14. The electrode of any one of aspects 1-13, further comprising one or more rheology modifiers, said rheology modifiers optionally present at 5 wt % or less.
Aspect 15. The electrode of any one of aspects 1-14, wherein said electrode active material comprises a binder, said binder having a glass transition temperature (Tg) of 30 degrees Celsius or lower, optionally −10 degrees Celsius or lower.
Aspect 16. The electrode of any one of aspects 1-15, further comprising a conductive agent, an electrically conductive polymer, or both.
Aspect 17. The electrode of aspect 16, wherein said conductive agent comprises carbon, optionally carbon black or graphitic carbon.
Aspect 18. The electrode of any one of aspects 1-7, wherein said current collector is porous.
Aspect 19. The electrode of aspect 18, wherein said current collector comprises a perforated coil structure.
Aspect 20. A process of producing the electrode of any one of claims 1-19 comprising: forming a paste comprising the electrode active material; extruding said paste onto either said current collector or said first fluid permeable sheet layer; and calendering said electrode active material to a final thickness of 0.5 mm to 10 mm, optionally 1 mm to 5 mm.
Aspect 21. The process of aspect 20 further comprising contacting said electrode with a second fluid permeable sheet layer, said second fluid permeable sheet layer on or in a second surface of said electrode active material.
Aspect 22. The process of aspect 20-21, wherein said first fluid permeable sheet layer has a Gurley air permeability of 100 L/sec/m² or greater.
Aspect 23. The process of aspects 20-22, wherein said fluid permeable sheet layer is non-woven.
Aspect 24. The process of aspects 20-23, wherein said fluid permeable sheet layer comprises pores with a cross sectional dimension of 20 m or greater.
Aspect 25. The process of any one of aspects 20-24, wherein said electrode has a Young's modulus of 1 GPa or less, optionally 0.5 GPa or less.
Aspect 26. The process of any one of aspects 20-25, wherein said electrode active material comprises activated carbon.
Aspect 27. The process of any one of aspects 20-26, wherein said paste further comprises a binder, said binder present a 10 wt % or less.
Aspect 28. The process of any one of aspects 20-27, wherein said electrode active material comprises activated carbon, has a thickness of greater than 0.5 mm, and said paste further comprises a binder at less than 10 wt % relative to said electrode active material.
Aspect 29. The process of any one of aspects 20-28, wherein said electrode active material is a solid.
Aspect 30. The process of any one of aspects 20-29, wherein said electrode has a density of about 2.5 g/cc or less, optionally about 2.0 g/cc or less, optionally about 1.5 g/cc, optionally about 1 g/cc or less, optionally about 0.5 g/cc or less.
Aspect 31. The process of any one of aspects 20-30, wherein said paste further comprises one or more rheology modifiers, said rheology modifiers optionally present at 5 wt % or less.
Aspect 32. The process of any one of aspects 20-31, wherein said paste comprises a binder, said binder having a glass transition temperature (Tg) of 50 degrees Celsius or lower, optionally −10 degrees Celsius or lower.
Aspect 33. The process of any one of aspects 20-32, wherein said paste further comprises a conductive agent, an electrically conductive polymer, or both.
Aspect 34. The process of aspect 33, wherein said conductive agent comprises carbon, optionally carbon black or graphitic carbon.
Aspect 35. The process of any one of aspects 20-34, wherein said current collector is porous.
Aspect 36. The process of aspect 35, wherein said current collector comprises a perforated coil structure.
Aspect 37. The process of any one of aspects 20-36, wherein said paste comprises 60 wt % solvent or less.
Aspect 38. The process of aspect 37, wherein said solvent or comprises water.
Aspect 39. A supercapacitor comprising the electrode of any one of aspects 1-19.
Aspect 40. A battery comprising the electrode of any one of aspects 1-19.
Aspect 41. A supercapacitor comprising an electrode made by the process of any of claims 20-38.
Aspect 43. A battery comprising an electrode made by the process of any of claims 20-38.

The foregoing description of particular aspect(s) is merely exemplary in nature and is in no way intended to limit the scope of the invention as claimed below, its application, or uses, which may, of course, vary. The disclosure is provided with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that when an element is referred to as “contacting” another element, it can be directly on the other element or intervening elements may be present therebetween. In contrast, when an element is referred to as “directly contacting” another element, there are no intervening elements present.

It will be understood that, although the terms “first,” “second,” “third”, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

In view of the foregoing, it is to be understood that other modifications and variations of the present invention may be implemented. The foregoing drawings, discussion, and description are illustrative of some specific embodiments of the invention but are not meant to be limitations upon the practice thereof. It is the following claims, including all equivalents, which define the scope of the invention.

1. An electrode comprising:
an electrode active material layer comprising an electrode active material, the electrode active material;
a current collector incorporated into said electrode active material or otherwise in electrical contact with the electrode active material; and
a first fluid permeable sheet layer, said fluid permeable sheet layer on or in a first surface of said electrode active material layer,
optionally wherein said electrode comprises less than 1 wt % liquid,
optionally wherein said electrode is free of surface cracks.

2. The electrode of claim 1 further comprising a second fluid permeable sheet layer, said second fluid permeable sheet layer on or in a second surface of said electrode active material.

3. The electrode of claim 1, wherein said electrode active material layer has a thickness of 0.5 mm to 10 mm.

4. The electrode of claim 1, wherein said first fluid permeable sheet layer has a Gurley air permeability of 1.0 L/sec/m² or greater.

5. (canceled)

6. The electrode of claim 1, wherein said fluid permeable sheet layer is non-woven.

7. The electrode of claim 1, wherein said fluid permeable sheet layer comprises pores with a cross sectional dimension of 10 μm or greater.

8. The electrode of claim 1, wherein said electrode has a Young's modulus of 1 GPa or less, optionally 0.5 GPa or less, or
wherein the electrode has a yield point of equal to or greater than 2% strain, optionally equal to or greater than 3% strain.

9. The electrode of claim 1, wherein said electrode active material layer comprises an electrode active material comprising carbon, said carbon present at 50 wt % or greater.

10. The electrode of claim 1, wherein said electrode active material layer further comprises a binder, said binder present at 10 wt % or less.

11. The electrode of claim 1, wherein said electrode active material layer comprises activated carbon, the electrode has a thickness of greater than 0.5 mm, and comprises a binder at less than 10 wt % relative to said electrode active material, and optionally further includes one or more electrically conductive polymers.

12-14. (canceled)

15. The electrode of claim 1, wherein said electrode active material layer comprises a binder, said binder having a glass transition temperature (Tg) of 30 degrees Celsius or lower.

16-18. (canceled)

19. The electrode of claim 1, wherein said current collector comprises a perforated coil structure.

20. A process of producing the electrode of claim 1 comprising:
forming a paste comprising the electrode active material;
extruding said paste onto either said current collector or said first fluid permeable sheet layer; and
calendering said electrode active material to a final thickness of 0.5 mm to 10 mm.

21. The process of claim 20 further comprising contacting said electrode with a second fluid permeable sheet layer, said second fluid permeable sheet layer on or in a second surface of said electrode active material.

22. The process of claim 20, wherein said first fluid permeable sheet layer has a Gurley air permeability of 100 L/sec/m² or greater.

23. The process of claim 20, wherein said fluid permeable sheet layer is non-woven.

24. The process of claim 20, wherein said fluid permeable sheet layer comprises pores with a cross sectional dimension of 20 μm or greater.

25. The process of claim 20, wherein said electrode has a Young's modulus of 1 GPa or less.

26. The process of claim 20, wherein said electrode active material comprises carbon.

27. (canceled)

28. The process of claim 20, wherein said electrode active material comprises activated carbon, has a thickness of greater than 0.5 mm, and said paste further comprises a binder at less than 10 wt % relative to said electrode active material.

29-38. (canceled)
